(19) United States
(12) Patent Application Publication
(10) Pub. No.: US 2001/0047356 A1
(43) Pub. Date: Nov. 29, 2001

(54) Advanced method and system of automatic population and maintenance of a web-based database

(76) Inventors: Tom Ren, Houston, TX (US); Ying Xiong, Houston, TX (US)

Correspondence Address: Tim W. Curington, 4035 Oakridge Street, Houston, TX, 77009, US

(21) Appl. No.: 09/834,701

(22) Filed: Apr. 12, 2001

Related U.S. Application Data
(60) Provisional application No. 60/197,902, filed on Apr. 15, 2000.
(60) Provisional application No. 60/232,770, filed on Sep. 15, 2000.

(51) Int. Cl. G06F 7/00

(52) U.S. Cl. 707/9

(57) ABSTRACT

The present invention provides a remotely accessible and maintained web-based database.

This application claims the benefit of U.S. Provisional Application No. 60/197,902, filed Apr. 15, 2000, and U.S. Provisional Application No. 60/232,770, filed Sep. 15, 2000.

### FIELD OF THE INVENTION

The present invention relates to a web-based database. More specifically, the present invention relates to the automatic population of a database, automatic notification to the individual account members of the database, and automatic maintenance of the database.

### BACKGROUND OF THE INVENTION

Databases are abundantly used for maintaining pertinent business records such as customer lists. Typically each record within the database pertains to an individual customer or contact and is used to store information about the customer or contact such as name, address, phone number, fax number, etc. Such databases are useful to provide the owner of the database with mailing lists to enable correspondence when necessary. For example, the records of the database may contain information such as whether the customer has paid the last invoice. In that instance, the database owner can access all of the records of individuals who have not paid their last invoice so that additional correspondence can be initiated.

A perpetual problem associated with customer databases is the maintenance of the records. A large corporation may have a customer database with hundreds of thousands of entries. As such, it is incumbent upon the corporation to continuously update the customer information as it changes. For example, if a customer has a changed mailing address, in order for the database to be maintained properly, the customer must notify the corporate manager of the database, and the manager must manually update the database. However, as is often the case, the process of being notified of a change generally does not occur until mail is returned or forwarded. The result is that either the customer, the database manager, or both remain unaware that the database is no longer correct for a substantial period of time. Thus, keeping the database current requires considerable effort on the part of the employees of the corporation, requires considerable correspondence between the client and the database manager, and consumes considerable time when dealing with extremely large databases.

There exists, therefore, a need for a method and system that enables automatic update of the database as customer or contact information changes.

Another problem associated with databases is that they are essentially static in that they merely supply information rather than initiate contact based upon the information. For example, rather than contact the customers directly, databases typically print out mailing labels or the like to enable employees of the corporation to mass mail the information. However, with extremely large databases, such mailing processes are extremely cumbersome and often result in inefficient delay.

There exists, therefore, a need for a method and system that enables instant notification of the individual customers whose records exists within a database.

### BRIEF DESCRIPTION OF THE DRAWINGS

FIG. 1 is a flow diagram of a general overview of a preferred embodiment of the method and system of the present invention.

FIG. 2 is a flow diagram of a preferred embodiment of the method and system of automatically populating a web-based database.

FIG. 3 is a flow diagram of a preferred embodiment of the method and system used to automatically generate temporary access accounts and notify the individual customers.

FIG. 4 is a flow diagram of a preferred embodiment of the method and system used to generate the temporary access accounts.

FIG. 5 is a flow diagram of a preferred embodiment of the method and system used to access and update the web-based database with a temporary access account.

FIG. 6 is a flow diagram of a preferred embodiment of the method and system used to access and update the web-based database with permanent access data.

FIG. 7 is a flow diagram of a preferred embodiment of the method and system used to simultaneously contact the individual customers whose records are stored within the web-based database.

FIG. 8 is a flow diagram of a preferred embodiment of the method an system of the present invention whereby an individual customer has access to the web-based database by use of his or her permanent access data.

FIG. 9 is a flow diagram of a preferred embodiment of the present invention in which the process software simultaneously transmits messages to individual customers.

### DETAILED DESCRIPTION OF THE PREFERRED EMBODIMENT

In the following detailed description of the preferred method and system of automatically populating, notifying, maintaining and updating a web-based database, the invention is described as being used to maintain a customer list. The present invention is not, however, restricted to such use. Those skilled in the art will recognize that the present invention may be used to advantage for any number of database systems such as vendor lists, dealer lists, directory listings, census surveys, taxpayer lists, traffic violation offender lists, or the like. Additionally, the database populated and maintained by the present invention can contain real property records, personal property records, service records, etc. However, for purposes of illustration and not for limitation, the present invention will be described with reference to the maintenance of a customer list.

It should also be noted that as used herein, the term “web-based” refers to Internet residence. In other words, “web-based” refers to processing systems and communications systems linked by the Internet. However, one skilled in the art will recognize that the present invention can be used to advantage on a smaller scale across an Intranet or self-contained network system.

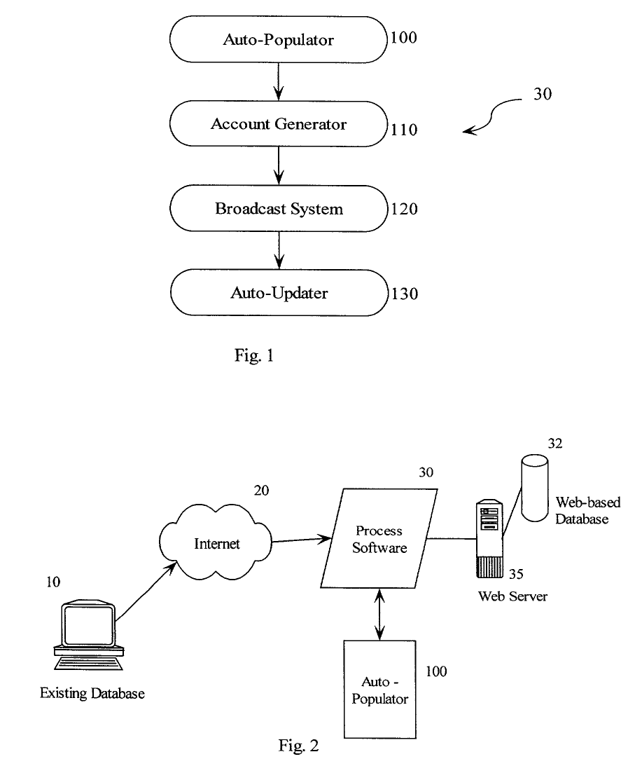

FIG. 1 provides a flow diagram of a general overview of the method and system of the present invention. In a preferred embodiment of the present invention, the system comprises process software, indicated generally at 30, located on a computer server with Internet access. The process software 30 comprises an Auto-Populater 100, an Account Generator 110, a Broadcast System 120, and an Auto-Updater 130. Initially the Auto-Populater 100 performs the task of receiving data from an existing database and automatically populating a web-based database. The Account Generator 110 then creates a temporary access account for each of the individual records within the database. A notification message is subsequently broadcast to all of the contacts of the individual records by the Broadcast System 120. Finally the Auto-Updater 130 enables automatic update of the individual records populating the web-based database.

The existing database 10 is, for example, a customer list stored on a company computer. The existing database 10 stores numerous records containing information such as, but not limited to, name, address, phone number, fax number, email address, etc. Each individual record corresponds to an individual client, contact or customer (hereinafter “customer”) whose information is stored within the database. It should be noted that although the existing database 10 in a preferred embodiment of the present invention is stored on a storage medium such as a computer, one skilled in the art will recognize that the existing database 10 can exist on any storage device or even exist on paper only and still remain within the purview of the present invention. In a preferred embodiment, the web-based database 32 is a database existing on a computer accessible across the Internet, such as a web server as known in the art. Similarly, the process software 30 is located on a computer with access to the web-based database 32 that executes the instructions provided by the process software 30. In a preferred embodiment of the present invention, the web-based database 32 and the process software 30 both exist on a single web server 35. However, one skilled in the art will recognize that the web-based database 32 and the process server 30 can be located on separate computers.

FIG. 2 is a flow diagram of a preferred embodiment of the method and system of automatically populating a web-based database 32. The method and system of automatically populating the web-based database 32 involves a data transfer from an existing database 10 to the web-based database 32 across a connection medium such as the Internet 20. The data transfer is facilitated by the Auto-Populator 100 of the process software 30.

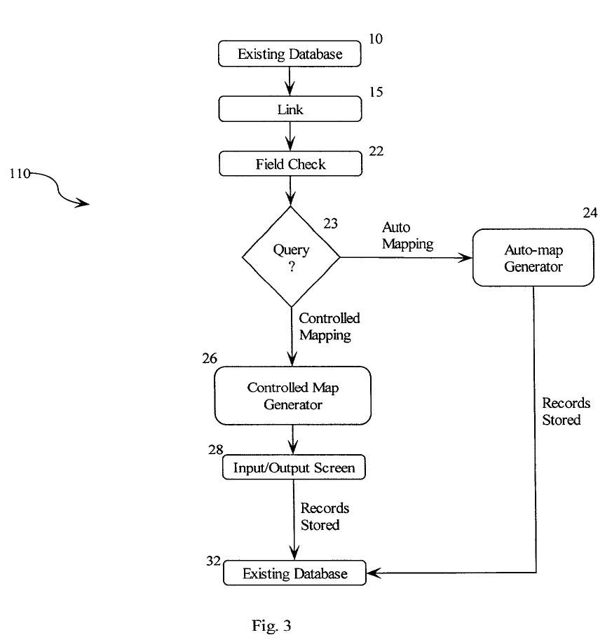

FIG. 3 illustrates a more detailed flow chart of the steps performed by the Auto-Populator 100 of the process software 30. In a preferred embodiment of the present invention, in order for the individual records of the existing database 10 to be transferred to the web-based database 32, a link 15 must be established between the existing database 10 and the Auto-Populator 100 across the Internet 20. The term “link” as used herein refers to a connection enabling electronic transfer of data, such as by email, for example. The link 15 is established by the end user connecting the computer within which the existing database 10 resides to the Auto-Populator 100. Similarly, the link 15 can be established by connecting a computer which has access to the existing database 10, across a network for example, to the Auto-Populator 100.

Although a preferred embodiment of the present invention establishes a link 15 between the existing database 10 and the Auto-Populator 100 across the Internet 20, one skilled in the art will recognize that other means of establishing a link 15 are available. For example, the link 15 can be established by means such as satellite systems, cable systems, direct modem connections, network connections, VPN connections, or Intranet connections. Additionally, one skilled in the art will recognize that there does not need to be any link at all to enable automatic population of the web-based database 32. For example, the existing database 10 can be stored on a magnetic storage device such as a computer disk and delivered to the Auto-Populator 100 for direct upload of the existing database 10 into the web-based database 32. Finally, one skilled in the art will recognize that if the existing database 10 exists on paper only, for example, the web-based database 32 can be automatically populated by transmitting the data to the Auto-Populator 100 through a scanner as known in the art, for example. In the event that the existing database 10 exists on a medium not suitable for scanning, then the existing database 10 must be manually entered into the web-based database 32 by data entry as known in the art.

Once the records of the existing database 10 have been electronically transferred to the Auto-Populator by the link 15, the field check 22 module of the Auto-Populator 100 performs a SQL search of the existing database 10 to detect record fields. After the field check 22 performs the SQL search, the Auto-Populator 100 prompts the end user for input regarding the type of mapping that is desired. The Auto-Populator 100 prompts the end user by sending a query 23 to the computer manned by the end user across the electronic connection The end user is prompted by an input/output processor, as is known in the art, to select either automatic or controlled mapping. If the end user selects automatic mapping, the auto-map generator 24 sets up a database map based on the detected record fields in the existing database 10 and the corresponding pre-defined data fields in the web-based database 32. It should be noted that mapping of database fields is well known in the art, and one of ordinary skill in the art will recognize the numerous ways of accomplishing such mapping. All such methods employed by the Auto-Populator 100 are intended to fall within the purview of the invention.

The auto-map generator 24 is useful if there is a significant correlation between the detected record fields in the existing database 10 and the pre-defined data fields in the web-based database 32. However, if there is not a significant correlation, the end user can select the controlled map generator 26. If the controlled map generator 26 is selected, the Auto-Populator 100 sends an input/output screen 28 to the computer manned by the end user that displays the detected record fields in the existing database 10 and the pre-defined data fields in the web-based database 32. By using a processor, as known in the art, associated with the input/output screen, the end user can map the fields as desired, and input the database map into the Auto-Populator 100. The controlled map generator 26 allows the end user, and the Auto-Populator 100, great flexibility in transferring databases with varying numbers and types of data fields.

Using the database map created by the auto-map generator 24 or the controlled map generator 26, the Auto-Populator 100 stores the records of the existing database 10 into the fields of the web-based database 32. In this manner, the web-based database 32 is automatically populated with the records of the existing database 10.

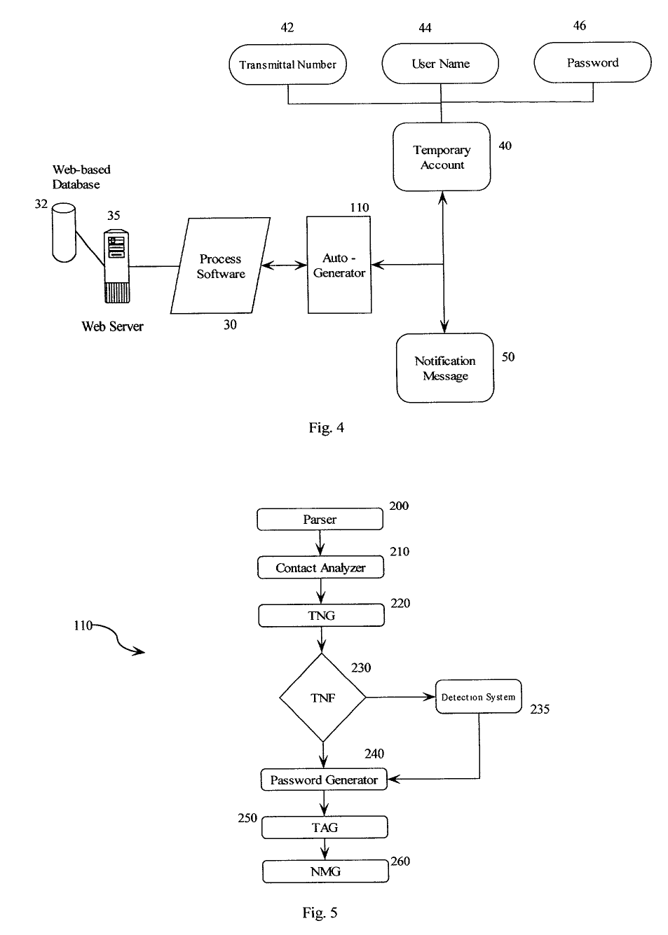

FIG. 4 is a flow diagram of a preferred embodiment of the Account Generator 110 of the process software 30. After the web-based database 32 is automatically populated, as discussed above, the Account Generator 110 generates temporary access accounts 40 and generates notification messages 50. The Account Generator 110 generates a temporary access account 40 for each individual record stored within the web-based database 32. Each individual record corresponds to an individual customer 60 whose information is stored within the database. The individual records contain information necessary to make contact with the individual customer 60 and includes, but is not limited to, such information as the mailing address, phone number, voice mail number, cellular phone number, pager number, beeper number, fax number, instant messaging address and/or email address of each individual customer 60. Additionally, the individual records can contain profile information. Profile information includes subject based information about the individual customer 60 such as types of products interested in or types of products sold, and includes location based information such as the territorial scope of the business practice of the individual customer 60.

In a preferred embodiment of the present invention, each temporary access account 40 that is generated includes a transmittal number 42, a user name 44, and a password 46. In a preferred embodiment of the present invention, the Account Generator 110 generates the temporary access accounts 40 by the method shown by the flow diagram of FIG. 5. For ease of discussion, the flow diagram of FIG. 5 is described with reference to subject matter illustrated in FIG. 4.

After receiving the individual records, the parser 200 reviews the individual records and parses out the contact information from the profile information, if any exists. The contact analyzer 210 then analyzes the contact information to determine the appropriate contact method to be used. As will be discussed herein, the process software 30 can contact the individual customers 60 by use of their mailing address, phone number, voice mail number, cellular phone number, pager number, beeper number, fax number, instant messaging address and/or email address. The end user of the process software 30 predetermines a primary number for contact. In a preferred embodiment of the present invention the preferred method of contact is by fax broadcast, thus the primary number is a fax number. The contact analyzer 210 of the Account Generator 110 analyzes the contact information to determine whether a primary number (i.e., fax number) exists. If so, the transmittal number generator (TNG) 220 of the Account Generator 110 sets the primary number as the transmittal number 42. If no primary number exists, the TNG 220 looks for a secondary number such as an email address, phone number, pager number, voice mail number, cell phone number, instant messaging address or mailing address to use as the transmittal number 42.

After the transmittal number 42 is set, the transmittal number filter (TNF) 230 performs a check to ensure that each transmittal number 42 is unique. If the transmittal number 42 is unique, it is sent directly to the password generator 240. If the transmittal number 42 is duplicative, the transmittal number 42 is sent to the detection system 235 to be flagged before being sent to the password generator 240. In a preferred embodiment of the present invention, the check of the transmittal numbers 42 performed by the TNF 230 eliminates the potential of duplicate user names 44 and passwords 46 being generated. If, for example, two or more individual customers 60 share identical fax numbers (i.e., employees of the same company), the TNF 230 is able to detect and flag the occurrence.

The password generator 240 of the Account Generator 110 generates a unique user name 44 and a password 46 related to each transmittal number 42. As discussed above, if a duplicative transmittal number is detected by the TNF 230, the password generator 240 receives a flagged transmittal number 42. The password generator 240 then alters the generation of the user name 44 and password 46 related to the duplicative transmittal number 42 to ensure that the combination of the transmittal number 42, the user name 44, and the password 46 are unique for each individual record. The temporary account generator (TAG) 250 creates the temporary access account 40 for each individual record by combining the transmittal number 42, user name 44, and password 46. Finally, the notification message generator (NMG) 260 generates a notification message 50 for each temporary access account 40. The notification message 50 includes the user name 44 and the password 42 of the temporary access account 40. Additionally, the notification message 50 includes access information used to enable the individual customer 60 to use their temporary access account 40 to access their individual records stored in the web-based database 32.

It should be noted that one skilled in the art will recognize that changes can be made to the above individual steps of creating the temporary access accounts 40 which do not change the manner in which the method and system or the present invention achieves the intended result. For example, depending upon the application, it may not be necessary to provide both a user name 44 and password 46 in the temporary account 40. Instead of generating a user name 44 or password 46, the name of the individual customer 60 could be used. One skilled in the art will recognize that all such changes are intended to fall within the purview of the method and system of the present invention.

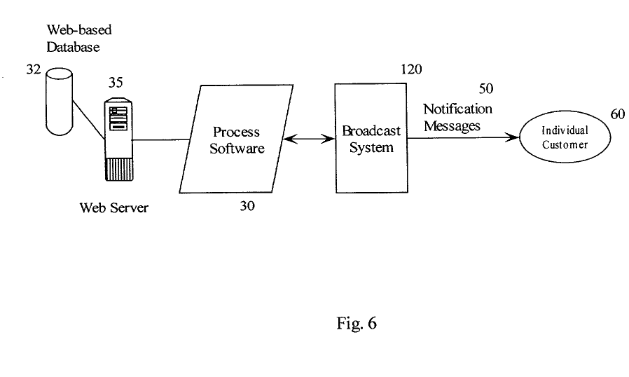

As shown in FIG. 6, after the temporary access accounts 40 and notification messages 50 are generated, the Broadcast System 120 of the process software 30 transmits the notification messages 50 to each of the individual customers 60 based upon the transmittal numbers 42 contained within the temporary access accounts 40. The manner in which the notification messages 50 are transmitted to the individual customers 60 depends upon the transmittal number 42. For example, if the transmittal number 42 for an individual customer 60 contains an email address, the Broadcast System 120 transmits the notification message 50 by electronic mail by means known in the art. Similarly, if the transmittal number 42 for an individual customer 60 contains a fax number and voice mail number, then the Broadcast System 120 transmits the notification message 50 by fax or voice mail using technology known in the art of fax broadcasting such as by CYNET, Inc. As discussed above, in a preferred embodiment of the present invention, the notification messages 40 are preferably broadcast by fax. The other means of transmittal are used as secondary means in the event that no fax number exists within the contact information of the individual customer 60.

Thus, in a preferred embodiment of the present invention, the entire notification process is web-based. The only exception to the process being entirely web-based occurs with individual customers 60 who have provided no contact information 44 other than a mailing address. In that instance, in a preferred embodiment of the present invention, the individual customers 60 must be contacted by conventional mailing methods.

It should be noted that although in a preferred embodiment of the present invention the notification process is performed solely by the Broadcast System 120 of the process software 30, one skilled in the art will recognize that external software may be used to advantage by the present invention. For example, the notification message 50 can be exported to an external software product capable of mass emailing, mailing, etc. as known in the art and still remain within the purview of the invention.

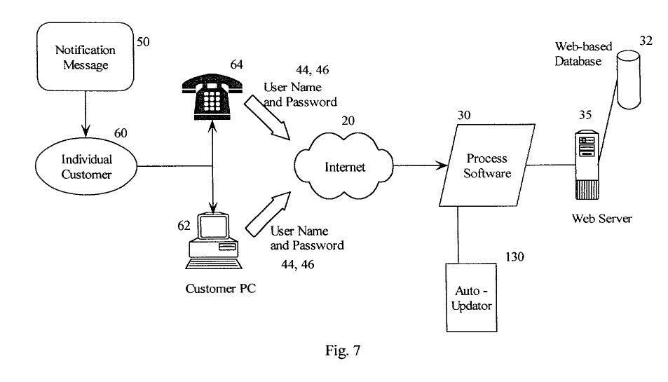

FIG. 7 is a flow diagram of a preferred embodiment of the Auto-Updater 130 of the process software 30 used to access and update the web-based database 32. Upon receipt of the notification message 50, the individual customers 60 can use the access information provided in the notification message 50 to access their individual records. In a preferred embodiment of the present invention, the notification message 50 provides access information such as the Internet 20 address of the Auto-Updater 130 to enable the individual customer 60 access from his or her computer 62. In addition, in order to accommodate the individual customers 60 who do not have access to the Internet 20, a toll free telephone number is provided to enable access to the Auto-Updater 130 through a telephone 64. Access to the Auto-Updater 130 by telephone 64 is provided by an Internet telephony gateway as known in the art. An example of a telephony gateway known in the art is the Cisco Internet Telephony Gateway AS5300 developed by Cisco Systems, Inc.

By utilizing the user name 44 and password 46 contained within the temporary access account 40 (shown in FIG. 4) and received in the notification message 50, the individual customer 60 can review his or her records stored within the web-based database 32. The individual customer 60 links with the Auto-Updater 130 either across the Internet 20 by use of a customer personal computer 62 or by a telephone 64 as discussed above and transmits his or her user name 44 and password 46. The Auto-Updater 130 performs a validation check and then provides access to the records of the individual customer 60 stored in the web-based database 32. The records are displayed on an output screen accessible by the Internet connection.

After reviewing his or her records, the individual customer 60 can make corrections or alterations to his or her individual records and the individual customer 60 can alter his or her user name 44 and his or her access password 46 if desired. In addition to correcting or altering the records of the individual customer 60, the individual customer 60 can also add data to expand the customer information such as profile information. For example, if the individual customer 60 has expanded his or her interests and wishes to receive information related to the area of expanded interest, the individual customer can automatically expand his or her customer information. Also, the individual customer 60 can restrict access to some or all of the data in his or her records stored in the web-based database 32. For example, the individual customer 60 may wish to restrict access to his or her email account information to prevent SPAM. In a preferred embodiment of the present invention, the individual customer 60 restricts access to particular data by toggling a switch associated with the particular data. All such amendments are affected by the individual customer 60 inputting data into the input/output processor, as known in the art, associated with the output screen.

After the individual customer 60 has reviewed and/or amended his or her records stored within the web-based database 32, the combination of the user name 44 and password 46 is maintained by the process software 30 as the permanent access data 70. Thus, if the individual customer 60 does not alter the user name 44 and password 46 of his or her temporary access account 40, then the user name 44 and password 46 generated by the process software 30 for the temporary account 40 becomes the permanent access data 70 of the individual customer 60. Similarly, if the individual customer 60 alters the user name 44 and password 46 of his or her temporary access account 40, then the altered user name 44 and password 46 becomes permanent access data 70 of the individual customer 60.

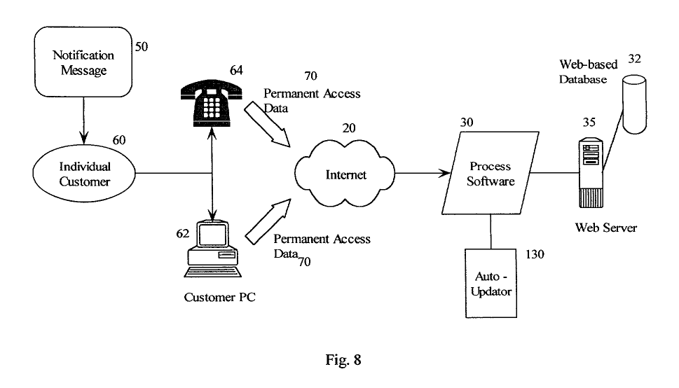

FIG. 8 illustrates a preferred embodiment of the present invention in which each individual customer 60 has access to the web-based database 32 by use of his or her permanent access data 70. The access to the web-based database 32 by use of the permanent access data 70 of the individual customer 60 is virtually identical to the access gained by use of the user name 44 and password 46 received in the temporary access account 40 described in FIG. 7. The individual customer 60 can access his or her records stored in the web-based database 32 by accessing the Auto-Updater 130 of the process software 30 across the Internet 20 through a computer 62, or the individual customer 60 can access the Auto-Updater 130 by use of a toll free telephone number. Once the Auto-Updater 130 verifies the permanent access data 70 transmitted by the individual customer 62 to the Auto-Updater 130, the individual customer 62 gains access to his or her records within the web-based database 32.

The Auto-Updater 130 provides easy access to the web-based database 32, either through the Internet 20 or via telephone 64 dialing a toll free number. As such, the individual customer 60 can continually and automatically update his or her records as they change. Likewise, the web-based database 32 is continually and automatically updated. If, for example, the individual customer 60 is relocating to another city, then the individual customer 60 can access the web-based database 32 through the Auto-Updater 130 and correct the information that is no longer current instantaneously. Thus, the web-based database 32 is automatically updated through the Internet 20 without requiring individual input or investigation by the end user of the web-based database 32.

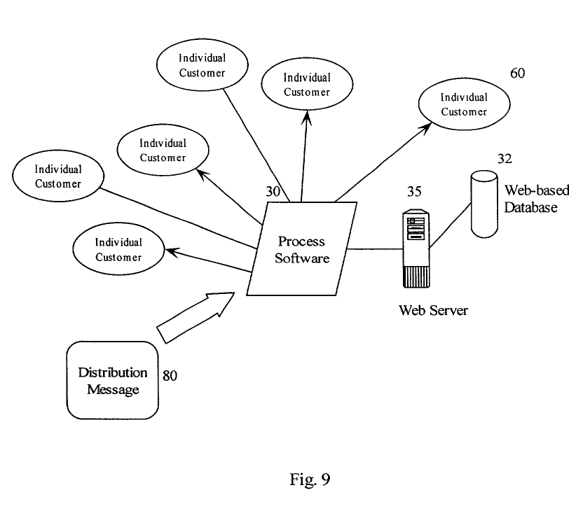

Because the web-based database 32 is continually and automatically updated, the process software 30 of the present invention can be used to provide more efficient communication with the individual customers 60. As shown in FIG. 9, the process software 30 can be used to simultaneously transmit messages to the individual customers 60 whose records are stored in the web-based database 32. For example, if an end user wishes to send a message to all or some of the individuals in the web-based database 32, the end user transmits the distribution message 80 to the process software 30. The end user also alerts the process software 30 as to the primary number for contact, if it is not already set. In a preferred embodiment of the present invention, after initial notification has been performed, the preferred method of messaging contact is by email, thus the primary number is an email address. The process software 30 analyzes the contact information contained in the individual records of the web-based database 32 to determine whether a primary number (i.e., email address) exists. For all of the individual records in which a primary number exists, the process software 30 transmits the distribution message 80 to the individual customers 60. For those individual records within which no primary number exists, the process software 30 looks for a secondary number such as a fax number, phone number, pager number, voice mail number, cell phone number, instant messaging address, or mailing address to use to transmit the distribution message 80.

Additionally, the end user can access the web-based database 32 through the process server 30 and download the updated database 32 directly to the end user's computer. The process server 30 transmits the records of the web-based database 32 directly to the end user such that the end user can maintain a copy of the web-based database 32 that has been continually and automatically updated by the method and system discussed above.

Although described in terms of the preferred embodiments shown in the figures, those skilled in the art who have the benefit of this disclosure will recognize that changes can be made to the individual steps or components thereof which do not change the manner in which the method and system achieves the intended result. For example, in a preferred embodiment of the present invention the individual customers have toll free telephone access to the web-based database through a telephony gateway. However, one skilled in the art will recognize that other known devices enabling telephone contact with a remote database can be used and remain within the purview of the invention. One skilled in the art will recognize that all such changes are intended to fall within the scope of the following non-limiting claims.

We claim:

1. A method of automatically populating, maintaining and updating a web-based database, the method comprising the steps of:
(a) receiving records of individuals from an existing database;
(b) populating a web-based database with the individual records;
(c) creating an access account for each individual record;
(d) transmitting the access account to the individuals; and
(e) enabling remote maintenance of the individual records by use of the access account.

2. The method of claim 1, wherein the records are received by transfer across an electronic link.

3. The method of claim 2, wherein the electronic link is electronic mail.

4. The method of claim 2, wherein the electronic link is select ed from satellite systems, cable systems, direct modem connections, network connections, VPN connections, or Intranet connections.

5. The method of claim 1, wherein the populating of the web-based database with the individual records further comprises automatically mapping the records.

6. The method of claim 1, wherein the populating of the web-based database with the individual records further comprises manually mapping the records.

7. The method of claim 1, wherein the access accounts are generated automatically.

8. The method of claim 1, wherein the temporary access accounts are transmitted to the individuals by fax.

9. The method of claim 1, wherein the temporary access accounts are transmitted to the individuals by email.

10. The method of claim 1, wherein the temporary access accounts are transmitted by a media selected from voice mail, physical address, or pager.

11. The method of claim 1, wherein the remote maintenance occurs across the Internet.

12. The method of claim 1, wherein the remote maintenance comprises altering the individual records.

13. A method of automatically updating data records stored in a web-based database, the method comprising the steps of:
(a) providing Internet access to the web-based database;
(b) generating passwords for the data records;
(c) automatically distributing the passwords; and
(d) providing Internet access to the data records through use of the passwords.

14. The method of claim 13 wherein the Internet access to the data records is provided for adding data to the records.

15. The method of claim 13 wherein the Internet access to the data records is provided for amending the data in the records.

16. The method of claim 13 wherein the Internet access to the data records is provided for restricting further access to the data in the records.

17. A remotely accessible data storage system, comprising:
(a) a database provided for storing customer data records;
(b) an account generator provided for creating access numbers for the data records;
(c) a broadcast system provided for distributing the access numbers to the customer; and
(d) an update system provided to enable customer access to the data records by use of the access numbers.

18. The remotely accessible data storage system of claim 17, wherein the database is a web-based database.

19. The remotely accessible data storage system of claim 17, wherein the customer data records include marketing profiles.

20. The remotely accessible data storage system of claim 17, wherein the broadcast system distributes the access numbers by facsimile.

21. The remotely accessible data storage system of claim 17, wherein the broadcast system distributes the access numbers by email.

22. The remotely accessible data storage system of claim 17, wherein the broadcast system distributes the access numbers by the media selected from voice mail, instant messaging, mail, or by pager.

23. The remotely accessible data storage system of claim 17, wherein the broadcast system distributes the access numbers by a combination of fax, email, and voice mail.
